(19) United States
(12) Patent Application Publication
(10) Pub. No.: US 2023/0408999 A1
(43) Pub. Date: Dec. 21, 2023

(54) Control Device Without Integrated Arrangement for Control and/or Monitoring

(71) Applicant: Siemens Schweiz AG, Zürich (CH)

(72) Inventor: Jens Jansen, Baar (CH)

(73) Assignee: Siemens Schweiz AG, Zürich (CH)

(21) Appl. No.: 18/251,592

(22) PCT Filed: Oct. 29, 2021
(86) PCT No.: PCT/EP2021/080086

§ 371 Date: May 3, 2023

(30) Foreign Application Priority Data
Nov. 5, 2020 (DE) 10 2020 213 933.4

(51) Int. Cl. G05B 19/05; G05B 24/02

(52) U.S. Cl. CPC G05B 19/054; G05B 2219/16; G05B 24/02

(57) ABSTRACT

Various embodiments of the teachings herein include a closed-loop and open-loop control device without integrated facility or with reduced integrated facility for operating and/or monitoring. The device may include: an attachment apparatus for attaching an external operating device; and a communication connection to receive user input from an input unit of the external operating device. The communication connection is used to provide information to an output unit of the external operating device.

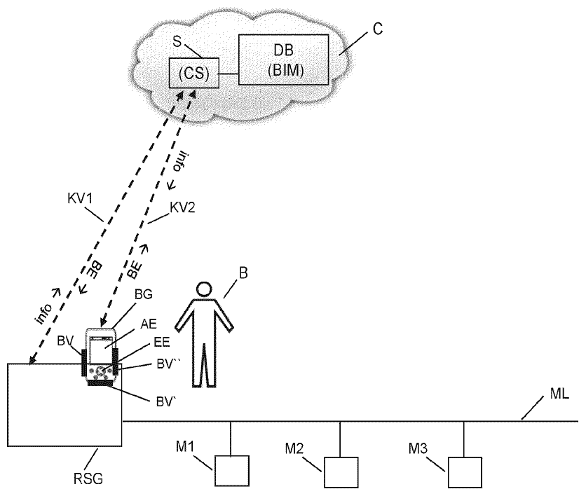

### CROSS-REFERENCE TO RELATED APPLICATIONS

This application is a U.S. National Stage Application of International Application No. PCT/EP2021/080086 filed Oct. 29, 2021, which designates the United States of America, and claims priority to DE Application No. 10 2020 213 933.4 filed Nov. 5, 2020, the contents of which are hereby incorporated by reference in their entirety.

### TECHNICAL FIELD

The present disclosure relates to control systems. Various embodiments of the teachings herein include closed-loop and open-loop control devices (black box panel), without integrated facility or with reduced integrated facility for operating and/or monitoring.

### BACKGROUND

For cost reasons, closed-loop and open-loop control devices can be equipped without an operator interface or only with a rudimentary operator interface. The operation of such closed-loop and open-loop control devices is complex and laborious for a user.

### SUMMARY

Teachings of the present disclosure provide for closed-loop and open-loop control device mechanisms which render it possible to operate the device in a simple manner. For example, some embodiments of the teachings herein include a closed-loop and open-loop control device (black box panel, controller, PLC), without integrated facility or with reduced integrated facility for operating and/or monitoring, comprising: an attachment apparatus for attaching an external operating device (for example tablet computer, smartphone, touch display); wherein the closed-loop and open-loop control device is configured so as via appropriate connection and/or communication means to receive user inputs (commands) from an input unit of the external operating device; and wherein the closed-loop and open-loop control device is further configured so as via the appropriate connection and/or communication means to output information on an output unit (display) of the external operating device. The attachment apparatus is configured so that operating units (for example touch displays) with different geometric dimensions can be fixedly connected to the closed-loop and open-loop control device (for example magnetically, or by a sliding-clamping mechanism or clips).

As another example, some embodiments include an arrangement for the operation of a fire alarm system, comprising: a closed-loop and open-loop control device (for example controller) for operating the fire alarm system; an external operating device (for example tablet computer, smartphone); wherein the closed-loop and open-loop control device has connection and/or communication means in order to receive user inputs (commands) from an input unit (for example touch screen) of the external operating device; and in order to output information on an output unit (display) of the external operating device; and an attachment apparatus for attaching the external operating device to the closed-loop and open-loop control device. The arrangement can be achieved using conventional components.

### BRIEF DESCRIPTION OF THE DRAWING

The teachings and example embodiment of the present disclosure are explained with the aid of the example of the following FIGURE. In the drawing:

The single FIGURES shows an exemplary arrangement for the operation of a fire alarm system comprising a closed-loop and open-loop control device without an integrated facility for operating and/or monitoring.

### DETAILED DESCRIPTION

Using the teachings of the present disclosure, the operating unit of the closed-loop and open-loop control devices described herein can be removed again from the mechanical attachment as required. In some embodiments, the attachment apparatus can be configured so that the operating unit remains permanently attached to the closed-loop and open-loop control device.

A closed-loop and open-loop control device with reduced integrated facility for operating and/or monitoring can comprise for example input buttons (for example switches) and/or LED lights for displaying the status. A closed-loop and open-loop control device with reduced integrated facility for operating and/or monitoring can be for example a closed-loop and open-loop control device without output graphics (for example an output apparatus without a display) and/or a closed-loop and open-loop control device without keypad input (or an input apparatus without a keypad). The external operating device is used for operating a further device that is connected to the closed-loop and open-loop control device.

In some embodiments, the closed-loop and open-loop control device comprises rudimentary (limited) means for operating and/or monitoring. This allows inputs to be entered on the closed-loop and open-loop control device even without using an external operating device.

In some embodiments, the attachment apparatus for attaching the external operating device is formed by a mechanical clamping and/or sliding mechanism. The clamping and/or sliding mechanism can already be integrated in the housing of the closed-loop and open-loop control device. The clamping and/or sliding mechanism can be a component of the housing of the closed-loop and open-loop control device. The clamping and/or sliding mechanism can be mounted on the housing of the closed-loop and open-loop control device or attached thereto in any manner. The clamping and/or sliding mechanism is mounted on the housing of the closed-loop and open-loop control device at the time of delivery. However, the clamping and/or sliding mechanism can also be subsequently attached to the housing of the closed-loop and open-loop control device.

In some embodiments, the closed-loop and open-loop control device is designed so that the external operating device is attached by a magnetic connection. The housing or a part of the closed-loop and open-loop control device has a suitable ferromagnetic material for this purpose. The housing of the external operating device or a part of the external operating device have a suitable material so that the external operating device can be attached to the closed-loop and open-loop control device on the basis of magnetism (for example ferromagnetism).

In some embodiments, the attachment apparatus is designed so that it is possible to remove an attached external operating device from the closed-loop and open-loop control device again. An external operating device can consequently be used for further closed-loop and open-loop control devices.

In some embodiments, the attachment apparatus is designed so that an attached external operating device remains permanently mechanically connected to the closed-loop and open-loop control device. The attachment apparatus is configured so that the external operating unit (external operating device) remains permanently attached to the closed-loop and open-loop control device and thus fulfills the EN54-2 requirements (CEN-CENELEC Standard EN54-2) (in particular with respect to the mechanical load test). Consequently, the closed-loop and open-loop control device (black box) becomes an EN54-2 panel with an operator control panel.

In some embodiments, the closed-loop and open-loop control device comprises means for supplying electrical power to the external operating device (for example tablet computer, smartphone). For example, the operating unit (external operating device) can be charged during the contact phase with the black box (closed-loop and open-loop control device). This can be performed for example in a contactless manner by induction and/or via an optional cable connection.

In some embodiments, the connection and/or communication means of the closed-loop and open-loop control device is designed so as to detect external operating devices that are located in the vicinity of the closed-loop and open-loop control device. This renders possible simple pairing or onboarding via Bluetooth, NFC, Wi-Fi, etc.).

In some embodiments, the closed-loop and open-loop control device is configured in such a manner that pairing is automatically performed between the closed-loop and open-loop control device and the external operating device when an external operating device located in the vicinity of the closed-loop and open-loop control device has been detected, wherein during pairing the external operating device and/or an appropriate operator can be authenticated and/or authorized. The operator and/or the external operating device are accordingly registered for this purpose with the closed-loop and open-loop control device beforehand. The registration is performed via a corresponding app on a suitably configured authorization server that in a closed-loop manner controls access to the closed-loop and open-loop control device. The authorization server is designed as a cloud server. Communication with the authorization server is via suitable communication means (for example radio, Internet).

In some embodiments, the external operating device can be operated immediately after pairing. Consequently, the external operating device can be used immediately by the user (for example service employee, commissioning technician) to make inputs on the closed-loop and open-loop control device.

In some embodiments, after pairing the external operating device can be operated by manually calling up a program (app) that is installed on the external operating device. This increases the security of access to the closed-loop and open-loop control device.

If the app is not available on the external operating device, the installation of the app may be automatically started when the external operating device is within radio range of the closed-loop and open-loop control device (for example in Bluetooth range).

If the app is not available on the external operating device, the installation of the app can also be started manually by the operator. A message is shown on the display of the external operating device that an installation is required. The option of implementing the installation automatically immediately via one-click (for example by clicking on a URL link) is offered. It is then possible to operate the black box (closed-loop and open-loop device) via the external operating unit by means of the app.

In some embodiments, communication between the external operating device and the closed-loop and open-loop control device is Internet-based via a cloud service. As a result, a simple registration and/or authorization of the external operating device for the appropriate closed-loop and open-loop control device is possible. A suitably configured cloud server provides the cloud service for this purpose.

In some embodiments, communication between the external operating device and the closed-loop and open-loop control device is Internet-based in such a manner that only one web browser is running on the external operating unit and the closed-loop and open-loop control device offers a web server via which the BE can be operated directly by means of the browser. Then there is no need for an extra app, for example, a cloud connection can be used once at some point in advance in order to pre-authenticate devices that may be connected according to the invention.

In some embodiments, after the external operating device is removed from the attachment apparatus, communication between the closed-loop and open-loop control device and the external operating device is automatically terminated. By virtue of the fact that the communication or the communication session between the closed-loop and open-loop control device and the external operating device is automatically terminated after the external operating device is physically removed from the attachment apparatus, unauthorized access to the closed-loop and open-loop control device is not possible.

In some embodiments, after the external operating device is disconnected from the connection and/or communication means, communication between the closed-loop and open-loop control device and the external control device is automatically terminated. By virtue of the fact that communication between the closed-loop and open-loop control device and the external operating device is automatically terminated after the external operating device is physically disconnected from the closed-loop and open-loop control device and the external operating device, unauthorized access to the closed-loop and open-loop control device is not possible.

It is possible at the closed-loop and open-loop control device and/or at the external operating device to configure whether or not communication (for example the data connection) between the closed-loop and open-loop control device and the operating device is terminated when the operating device is removed. It is possible at the closed-loop and open-loop control device and/or at the external operating device to configure the time period (defined period of time) at the end of which communication (for example the data connection) between the closed-loop and open-loop control device and the operating device is terminated. For example, it can be set that when the operating device is removed, communication (for example the data connection) between the closed-loop and open-loop control device and the operating device is terminated after, for example, 10 minutes, in particular after 5 minutes. If a service technician clips the external operating device back in, i.e. reconnects it to the closed-loop and open-loop control device, before the set time period has elapsed, communication between the operating device and the closed-loop and open-loop control device is automatically restored.

It is possible at the closed-loop and open-loop control device and/or at the external operating device to configure whether or not communication (for example the data connection) between the closed-loop and open-loop control device is terminated if a removed operating device is located outside an adjustable distance from the closed-loop and open-loop control device. For example, this distance can be determined and monitored via a signal strength and/or indoor localization.

In some embodiments, the closed-loop and open-loop device is used for detecting fires. Appropriate devices (for example loudspeakers, sirens, lights, warning displays) for fire alarm notification are activated by the closed-loop and open-loop control device via suitable connection and/or communication means.

In some embodiments, the attachment apparatus is integrated in the closed-loop and open-loop control device. This ensures that the attachment apparatus is available in the field when needed.

In some embodiments, the arrangement comprises a cloud server which is configured so as to communicate between the closed-loop and open-loop control device and the external operating device. A suitably configured cloud server with an appropriate cloud infrastructure provides a corresponding cloud service for this purpose.

The FIGURE shows an exemplary arrangement for the operation of a fire alarm system comprising a closed-loop and open-loop control device RSG, without integrated facility for operating and/or monitoring. The arrangement comprises: a closed-loop and open-loop control device RSG (for example controller, PLC) for operating the fire alarm system; an external operating device BG (for example tablet computer, smartphone); wherein the closed-loop and open-loop control device RSG has connection and/or communication means in order to receive user inputs BE (for example commands) from an input unit EE (for example touch screen) of the external operating device BG; and in order to output information info on an output unit AE (for example display) of the external operating device BG; and an attachment apparatus BV, BW, BV″ for attaching the external operating device BG to the closed-loop and open-loop control device RSG.

The attachment apparatus BV, BW, BV″ can be integrated in the closed-loop and open-loop control device RSG, for example in the housing of the closed-loop and open-loop control device RSG.

The arrangement can also include a cloud server S which is configured so as to communicate between the closed-loop and open-loop control device RSG and the external operating device BG. The cloud server S is connected to the closed-loop and open-loop control device RSG in terms of data technology via the communication connection KV1 (for example radio link, Internet). The cloud server S is connected to the external operating device BG in terms of data technology via the communication connection KV2 (for example radio link, Internet).

A user B (for example service employee or commissioning technician) can input user inputs BE (for example commands or configurations) at the input unit EE on the external operating device BG. The user inputs BE are transmitted via the communication connection KV2 to the cloud server S. The cloud server S transmits these user inputs BE for processing and/or for configuration to the closed-loop and open-loop control device RSG. Furthermore, the cloud server S can store received user inputs BE in the building information model BIM. The consistency of the building information model BIM with data in the field (for example current configurations of the closed-loop and open-loop control device RSG) is consequently ensured.

Outputs and/or messages info (for example status displays) of the closed-loop and open-loop control device RSG are transmitted via the communication connection KV1 to the cloud server S and from there they are transmitted via the communication connection KV2 to the external operating device BG. The messages info are output or displayed on the output unit AE (for example display and/or LED displays) of the external operating device BG.

As shown in the FIGURE, the cloud server S is implemented in a cloud infrastructure C. The cloud server S has access to a database DB. A building information model BIM can be stored inter alia in the database DB. If the closed-loop and open-loop control device RSG is used for building automation, for example for fire protection in a building, the closed-loop and open-loop control device RSG can access information stored in the building information model BIM, for example regarding the fire alarm system implemented in the building.

In the illustrated example, the closed-loop and open-loop control device RSG is used as the central unit of an alarm line ML with the three exemplary fire and/or hazard alarm devices M1-M3 of a fire alarm system.

The attachment apparatus BV, RV′, BV″ can be, for example, a clamping and/or a plug-in apparatus for fixing the external operating device BG. In some embodiments, the attachment apparatus BV, RV′, RV′ can comprise a magnetic connection for fixing the external operating device BG.

As an example, some embodiments include a closed-loop and open-loop control device RSG (for example black box panel, controller, PLC), without integrated facility or only with reduced facility for operating and/or monitoring, comprising: an attachment apparatus BV, BW, BV″ for attaching an external operating device BG (for example tablet computer, smartphone, touch display); wherein the closed-loop and open-loop control device RSG is configured to receive user inputs BE (for example commands) from an input unit EE of the external operating device BG via appropriate connection and/or communication means (for example plugs for a cable connection and/or radio link (for example Bluetooth); wherein the closed-loop and open-loop control device RSG is further configured so as via the appropriate connection and/or communication means to output information info (for example status displays, messages) on an output unit AE (for example display) of the external operating device BG. The attachment apparatus BV, BW, BV″ is configured so that external operating units BG (for example touch displays) with different geometric dimensions can be fixedly connected to the closed-loop and open-loop control device RSG (for example magnetically, and/or by a sliding-clamping mechanism or clips). The operating unit BG can be easily removed again from the mechanical attaching as required. In some embodiments, the attachment apparatus BV, BW, BV″ can be configured so that the operating unit BG remains permanently attached to the closed-loop and open-loop control device RSG.

In some embodiments, the closed-loop and open-loop control device RSG comprises rudimentary and/or limited means for operating and/or monitoring. This allows inputs BE to be entered on the closed-loop and open-loop control device RSG even without using an external operating device BG.

In some embodiments, the attachment apparatus BV, BW, BV″ for attaching the external operating device BG is formed by a mechanical clamping and/or sliding mechanism. The clamping and/or sliding mechanism can already be integrated in the housing of the closed-loop and open-loop control device RSG. The clamping and/or sliding mechanism can be a component of the housing of the closed-loop and open-loop control device RSG. The clamping and/or sliding mechanism can be mounted on the housing of the closed-loop and open-loop control device RSG or attached thereto in any manner. The clamping and/or sliding mechanism is mounted on the housing of the closed-loop and open-loop control device RSG at the time of delivery. However, the clamping and/or sliding mechanism can also be subsequently attached to the housing of the closed-loop and open-loop control device RSG.

In some embodiments, the closed-loop and open-loop control device RSG is designed in such a manner that the external operating device BG is attached by a magnetic connection. The housing or a part of the closed-loop and open-loop control device RSG has a suitable ferromagnetic material for this purpose. The housing of the external operating device BG or a part of the external operating device BG advantageously have a suitable material so that the external operating device BG that can be attached to the closed-loop and open-loop control device RSG on the basis of magnetism (for example ferromagnetism).

In some embodiments, the attachment apparatus BV, BW, BV″ is designed in such a manner that it is possible to remove an attached external operating device BG from the closed-loop and open-loop control device RSG again. An external operating device BG can consequently be used for further closed-loop and open-loop control devices.

In some embodiments, the attachment apparatus BV, BW, BV″ is designed in such a manner that an attached external operating device BG remains permanently mechanically connected to the closed-loop and open-loop control device again. The attachment apparatus BV, BW, BV″ is configured so that the external operating unit BG (external operating device) remains permanently attached to the closed-loop and open-loop control device RSG and thus fulfills the EN54-2 requirements (CEN-CENELEC Standard EN54-2) (in particular with respect to the mechanical load test). This turns a black box into an EN54-2 panel with operator control panel.

In some embodiments, the closed-loop and open-loop control device RSG comprises means for supplying electrical power to the external operating device BG (for example tablet computer, smartphone). Thus, for example, the operating unit BG (external operating device) can be charged during the contact phase (usage period) with the black box (closed-loop and open-loop control device RSG). This can be performed for example in a contactless manner by induction and/or via an optional cable connection.

In some embodiments, the connection and/or communication means of the closed-loop and open-loop control device RSG is designed in such a manner so as to detect external operating devices BG that are located in the vicinity of the closed-loop and open-loop control device RSG. This renders possible simple pairing or onboarding via Bluetooth, NFC, Wi-Fi, etc.).

In some embodiments, the closed-loop and open-loop control device RSG is configured in such a manner that pairing is automatically performed between the closed-loop and open-loop control device RSG and the external operating device BG when an external operating device located in the vicinity of the closed-loop and open-loop control device RSG has been detected, wherein during pairing the external operating device BG and/or an appropriate operator can be authenticated and/or authorized. Advantageously, the operator and/or the external operating device BG are registered with the closed-loop and open-loop control device RSG beforehand. The registration is carried out via an appropriate app on a suitably configured authorization server that controls access to the closed-loop and open-loop control device RSG. The authorization server is designed as a cloud server. Communication with the authorization server is via suitable communication means KV1, KV2 (for example radio, Internet).

In some embodiments, the external operating device BG can be operated immediately after pairing. Consequently, the external operating device BG can be used immediately by the user (for example service employee, commissioning technician) to make inputs on the closed-loop and open-loop control device RSG.

In some embodiments, after pairing the external operating device BG can be operated by manually calling up a program (app) that is installed on the external operating device BG. This increases the security of access to the closed-loop and open-loop control device RSG.

If the app is not available on the external operating device BG, the installation of the app may be automatically started when the external operating device BG is within radio range of the closed-loop and open-loop control device RSG (for example in Bluetooth range).

If the app is not present on the external operating device BG, the installation of the app can be started manually by the operator B. A message is shown on the display AE of the external operating device BG that an installation is required. The option of implementing the installation automatically immediately via one-click (for example by clicking on a URL link) is offered. It is then possible to operate the closed-loop and open-loop device RSG via the external operating unit BG by means of the app.

In some embodiments, communication between the external operating device BG and the closed-loop and open-loop control device RSG is Internet-based via a cloud service CS. As a result, a simple registration and/or authorization of the external operating device for the appropriate closed-loop and open-loop control device RSG is possible. A suitably configured cloud server S provides the cloud service CS for this purpose.

In some embodiments, after the external operating device BG is removed from the attachment apparatus BV, BW, BV″, communication between the closed-loop and open-loop control device RSG and the external operating device BG is automatically terminated. By virtue of the fact that the communication or the communication session between the closed-loop and open-loop control device RSG and the external operating device BG is automatically terminated after the external operating device BG is physically removed from the attachment apparatus, unauthorized access to the closed-loop and open-loop control device RSG is not possible.

In some embodiments, after the external operating device BG is disconnected from the connection and/or communication means, communication between the closed-loop and open-loop control device RSG and the external control device BG is automatically terminated. By virtue of the fact that the communication between the closed-loop and open-loop control device RSG and the external operating device BG is automatically terminated after the external operating device BG is physically disconnected from the closed-loop and open-loop control device, unauthorized access to the closed-loop and open-loop control device RSG is not possible.

In some embodiments, the closed-loop and open-loop device RSG is used for detecting fires. The closed-loop and open-loop control device RSG activates appropriate devices (for example loudspeakers, sirens, lights, warning displays) for fire alarm notification via suitable connection and/or communication means.

However, communication between the external operating device BG and the closed-loop and open-loop control device RSG can also be direct, for example via a suitable radio link (for example Bluetooth) and/or cable-based (using appropriate plug-in connections for a cable connection).

Various embodiments of the teachings herein can be used for devices RSG (black box), in particular control devices, with no or only reduced display and/or only a reduced operating unit (buttons, loudspeakers, etc.)). They can also be used for a central fire alarm system, without a user interface or with only a rudimentary (i.e. reduced) user interface.

The teachings can also be used on “central units” (products) with a normal operating panel. Thus, the additionally attached operator control panel would additionally simplify the operation (second operator control panel or comfortable operator control panel (for example larger, in color)).

This renders it possible to operate such a black box in a very simple manner. During the operation, the hands of the operator are free and there is no risk of a poorly stored tablet falling to the ground or breaking. The process of connecting the control unit and the black box is very simple and is reduced to very few operations, with the advantage of a single manipulation: clip in and attach the operating unit BG in the black box.

Some embodiments include a mechanical apparatus for attaching an external operating unit BG (for example conventional smartphone, tablet, notebook, netbook, etc.). The apparatus is designed so that operating units with different geometric dimensions can be fixedly connected (for example magnetically, or by a sliding-clamping mechanism or clips). The operating unit BG can be easily removed again from the mechanical attachment as required.

In some embodiments, the apparatus can be configured so that the control unit BG remains permanently attached and the EN54-2 requirements (mechanical load test) are fulfilled. Consequently, in this manner a black box becomes an EN54-2 panel with operator control panel.

In some embodiments, the operating unit BG can be charged during the contact phase with the black box RSG (for example in a contactless manner by induction or an optional cable connection. The black box RSG (for example closed-loop and open-loop control device, controller, PLC, SPS) advantageously has a mechanism via which an operating unit BG (for example tablet computer) that is attached or located in the vicinity is detected (for example a mechanical switch or electrically via Bluetooth, NFC, Wi-fi, etc.).

In some embodiments (depending on security requirements), pairing is performed (black box with operating unit), which authenticates and authorizes the operating unit BG and/or the operator B. When a detected operating unit BG is recognized, communication is established between the black box (closed-loop and open-loop control device) RSG and the external operating unit BG.

Communication between the external operating unit BG and the closed-loop and open-loop control device RSG can be via different communication paths:
a) Communication between the external operating unit BG and the closed-loop and open-loop control device RSG can be indirect, for example via a cloud C.
b) In the offline use case (=no Internet connection available for the operating unit BG and the closed-loop and open-loop control device RSG), communication between the external operating unit BG and the closed-loop and open-loop control device RSG is direct. For example in a contactless manner (for example via 5G, Wi-Fi, Bluetooth) or via cable (USB, Ethernet, etc.).
c) The external operating unit BG and the closed-loop and open-loop control device RSG can communicate via a network that is available in the building (for example Wi-fi).
d) If the closed-loop and open-loop control device RSG communicates with other closed-loop and open-loop control devices in a network, the external operating unit BG can also access and communicate with other closed-loop and open-loop control devices in the panel-to-panel network via this “panel-to-panel” network.

In some embodiments, the cloud C can also be accessed by the external operating unit BG via the panel-to-panel network and via an edge logic or a suitable edge gateway (for example Siemens X300 gateway) in this panel-to-panel network. The external operating unit BG accesses the panel-to-panel network via Wi-fi (WLAN).

In some embodiments, the external operating device BG or user B is authenticated before the actual communication. After pairing, the operating unit BG starts automatically or by manually calling up an app. In some embodiments, the operating unit BG starts via a browser call, i.e. by making the appropriate inputs in a corresponding browser menu.

In some embodiments, if the app is not available, the installation of the app is automatically started or manually started or the operating unit shows a message that an installation is required and offers an option to implement this automatically immediately per one-click. It is then possible to operate the black box RSG via the external operating unit BG by means of the app.

When the operating unit BG is removed from the mechanical or electrical connection, the black box breaks off the communication.

In some embodiments, a closed-loop and open-loop control device RSG, wherein after the external operating device BG is disconnected from the connection and/or communication means, communication between the closed-loop and open-loop control device RSG and the external operating device BG continues until, for example, a set time limit and/or a distance from BG to RSG is exceeded. The communication between the closed-loop and open-loop control device RSG and the external operating device BG can also be terminated manually, for example, by the service technician.

### REFERENCE CHARACTERS

M1-M3 Alarm device
RSG Closed-loop and open-loop control device
BG Operating device
ML Alarm line
BV, BV′, BV″ Attachment apparatus
KV1-KV2 Communication connection
EE Input unit
AE Output unit
S Server
CS Cloud service
DB Database
BIM Building information model
C Cloud
B User
BE User inputs
info Information

What is claimed is:

1. A closed-loop and open-loop control device without integrated facility or with reduced integrated facility for operating and/or monitoring, the device comprising:
an attachment apparatus for attaching an external operating device; and
a communication connection to receive user input from an input unit of the external operating device;
wherein the communication connection is used to provide information to an output unit of the external operating device.

2. The closed-loop and open-loop control device as claimed in claim 1, further comprising rudimentary means for operating and/or monitoring.

3. The closed-loop and open-loop control device as claimed in claim 1, wherein the attachment apparatus comprises a mechanical clamping and/or sliding mechanism.

4. The closed-loop and open-loop control device as claimed in claim 1, wherein the external operating device is attached by a magnetic connection.

5. The closed-loop and open-loop control device as claimed in claim 1, wherein the attachment apparatus is configured to allow removal of an attached external operating device.

6. The closed-loop and open-loop control device as claimed in claim 1, wherein the attachment apparatus creates a permanent mechanical connection to an attached external operating device.

7. The closed-loop and open-loop control device as claimed in claim 1, further comprising means for supplying electrical power to the external operating device.

8. The closed-loop and open-loop control device as claimed in claim 1, wherein the communication connection detects external operating devices located in a vicinity of the device.

9. The closed-loop and open-loop control device as claimed in claim 8, wherein:
pairing is automatically performed between the closed-loop and open-loop control device and the external operating device when an external operating device located in the vicinity of the closed-loop and open-loop control device has been detected; and
during pairing the external operating device and/or a corresponding operator can be authenticated and/or authorized.

10. The closed-loop and open-loop control device as claimed in claim 9, wherein the external operating device can be operated immediately after pairing.

11. The closed-loop and open-loop control device as claimed in claim 9, wherein after pairing the external operating device can be operated by manually calling up a program installed on the external operating device.

12. The closed-loop and open-loop control device as claimed in claim 1, wherein communication between the external operating device and the closed-loop and open-loop control device is Internet-based via a cloud service.

13. The closed-loop and open-loop control device as claimed in claim 1, wherein after the external operating device is removed from the attachment apparatus, communication between the closed-loop and open-loop control device and the external operating device is automatically terminated.

14. The closed-loop and open-loop control device as claimed in claim 1, wherein after the external operating device is disconnected from the communication connection, communication between the closed-loop and open-loop control device and the external control device is automatically terminated.

15. The closed-loop and open-loop control device as claimed in claim 1, wherein the closed-loop and open-loop control device is used for detecting fires.

16. An arrangement for the operation of a fire alarm system, the arrangement comprising:
a closed-loop and open-loop control device for operating the fire alarm system;
an external operating device;
wherein the closed-loop and open-loop control device has a communication connection to receive user input from an input unit of the external operating device and to transmit information on an output unit of the external operating device; and
an attachment apparatus for attaching the external operating device to the closed-loop and open-loop control device.

17. The arrangement as claimed in claim 16, wherein the attachment apparatus is integrated in the closed-loop and open-loop control device.

18. The arrangement as claimed in claim 16, further comprising
a cloud server configured to communicate between the closed-loop and open-loop control device and the external operating device.
